(19) United States
(12) Patent Application Publication
(10) Pub. No.: US 2025/0256524 A1
(43) Pub. Date: Aug. 14, 2025

(54) DEVELOPER COMPOSITION FOR PHENOL-FREE DIRECT THERMAL RECORDING MEDIUM

(71) Applicant: Appvion, LLC, Appleton, WI (US)

(72) Inventor: Mark R. Fisher, Appleton, WI (US)

(73) Assignee: Appvion, LLC, Appleton, WI (US)

(21) Appl. No.: 19/098,611

(22) Filed: Apr. 2, 2025

Related U.S. Application Data
(63) Continuation-in-part of application No. 18/826,847, filed on Sep. 6, 2024.
Application No. 18/826,847 is a continuation of application No. 17/407,491, filed on Aug. 20, 2021, now Pat. No. 12,115,803.
Application No. 17/407,491 is a continuation-in-part of application No. 17/118,217, filed on Dec. 10, 2020, now Pat. No. 12,151,498.

(51) Int. Cl. B41M 5/333; B41M 5/323; B41M 5/44

(52) U.S. Cl. CPC B41M 5/3333; B41M 5/323; B41M 5/44; B41M 2205/04; B41M 2205/38

(57) ABSTRACT

A recording medium has a substrate and a thermally responsive layer disposed on the substrate. The thermally responsive layer includes a leuco dye and at least one developer. The developer comprises an N,N′-diurea derivative of Structure I and an N,N′-diurea derivative of Structure II:

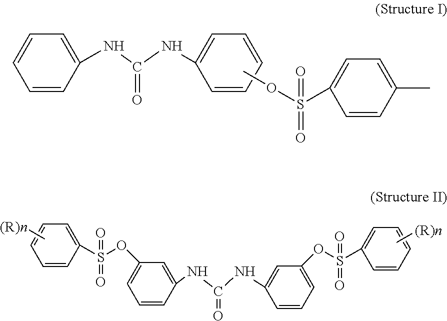

wherein each Rₙ is independently a C₁₋₇ alkyl group.

### CROSS-REFERENCE TO RELATED APPLICATIONS

This application is a continuation in part of U.S. Non-Provisional Utility application Ser. No. 18/826,847, filed on Sep. 6, 2024, titled: DEVELOPER COMPOSITION FOR PHENOL-FREE DIRECT THERMAL RECORDING MEDIA, which is a continuation of U.S. Pat. No. 12,115,803 issued Oct. 15, 2024 and titled: Fade-Resistant Water-Dispersible Phenol-Free Direct Thermal Media, which is a continuation in part of U.S. Pat. No. 12,151,498 issued Nov. 26, 2024 and titled: Multi-Purpose Phenol-Free Direct Thermal Recording Media, the contents of which are incorporated herein by reference.

### FIELD OF THE INVENTION

The present disclosure relates to sheet-like recording materials adapted to be recorded on or printed on by conventional direct thermal recording techniques, and more particularly to a developer composition for such recording materials, as well as related methods, systems, and articles.

### BACKGROUND

In direct thermal recording, an image is produced by selectively heating the recording material (sometimes called coated thermochromic paper, thermal paper, thermal recording material or media, or thermally-responsive record material) at selected locations by passing the material under, or otherwise across, a thermal print head. The recording material includes a coating of a thermally responsive layer, and the image is provided by a heat-induced change in color of the thermally responsive layer. Some common uses of direct thermal recording may include, without limitation, cash register receipts, labels for food or other goods, or event tickets.

Numerous types of direct thermal recording media are known. See, for example, U.S. Pat. No. 3,539,375 (Baum); U.S. Pat. No. 3,674,535 (Blose et al.); U.S. Pat. No. 3,746,675 (Blose et al.); U.S. Pat. No. 4,151,748 (Baum); U.S. Pat. No. 4,181,771 (Hanson et al,); U.S. Pat. No. 4,246,318 (Baum); and U.S. Pat. No. 4,470,057 (Glanz). In these cases, basic colorless or lightly colored chromogenic material, such as a leuco dye, and an acidic color developer material are contained in a coating on a substrate which, when heated to a suitable temperature, melts or softens to permit the materials to react, thereby producing a colored mark or image at the spot where the heat is applied. Thermally-responsive record materials have characteristic thermal responses, desirably producing a colored image of sufficient intensity or contrast upon selective thermal exposure.

Depending on how such recording materials are used, they can be exposed to certain contaminants or environmental conditions. For example, direct thermal media used as labels in pharmaceutical applications may be exposed to hand sanitizing liquid. Direct thermal media used in other applications may be exposed to environmental agents or conditions peculiar to such applications, such as sweat (water), heat and/or humidity, sunlight, or meat wrapping film, to name a few. Ideally, a bar code or other image thermally printed on a direct thermal recording material should remain visible and functional when exposed to such agents. But designing such capabilities into a direct thermal product can be difficult and is not always possible or practical.

Some direct thermal recording media have been described or proposed for specialized applications in which the substrate or base material of the product is a water-dissolvable or water-dispersible paper material (in contrast with conventional paper substrates, which are neither water-dissolvable nor water-dispersible), such that the resulting direct thermal record media as a whole can be easily dissolved or dispersed by the end user. See e.g. U.S. Pat. No. 7,476,448 (Natsui et al.). Some such products have been sold, but have suffered from poor quality image formation. That is, when such products are fed through a conventional direct thermal printer to print an image at a normal print speed, such as 6 inches per section (ips), the resulting image quality is typically so poor that a bar code image cannot be reliably scanned and read by standard bar code readers. The poor image quality is believed to be due to the outer surface of the product being too rough or non-smooth, which may result from puckering or swelling of the water-dispersible base stock during manufacturing when a first layer is coated in an aqueous solution onto the surface of the base stock.

Independent of these issues, concerns were raised many years ago about the presence of phenol-based chemicals in direct thermal recording materials. Originally, phenol material was present in the thermally responsive layer of the thermal recording material, and more specifically, in the developer chemical that reacts with the leuco dye in that layer to produce a thermally-induced change of color. Alternative, phenol-free developer chemicals were developed to address these concerns. One group of such chemicals was introduced by Ciba Specialty Chemical Corp. about 20 years ago under the brand Pergafast™, including Pergafast 201 (3-(3-Tosylureido) phenyl p-toluenesulfonate). This developer is still widely used today in the manufacture of phenol-free direct thermal recording materials. Some other known phenol-free developers include NKK 1304 (N-[2-(3- Phenylureido phenyl]benzenensulfonamide) sold by Nippon Soda Co. Ltd., Tolbutamide (1-butyl-3-(4-methylphenyl)sulfonyl urea), and Dapsone (4,4′-Diamino Diphenyl Sulfone).

Accordingly, it would be desirable to provide a developer composition that addressed one or more of these concerns while maintaining image quality.

### BRIEF SUMMARY

A recording medium is disclosed herein. In an embodiment, the recording medium comprises a substrate; and a thermally responsive layer disposed on the substrate, the thermally responsive layer including a leuco dye and at least one developer, wherein the developer comprises an N,N′-diurea derivative of Structure I and an N,N′-diurea derivative of Structure II:

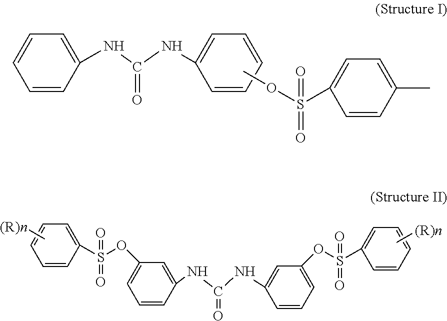

wherein each Rₙ is, independently, a C₁₋₇ alkyl group.

In some embodiments, each Rₙ group is independently selected from the group consisting of a methyl group, an ethyl group, a propyl group, an isopropyl group, an n-butyl group, a sec-butyl group, an isobutyl group, and a tert-butyl group. In further embodiments, each Rₙ group is the same and is a methyl group.

In embodiments, the N,N′-diurea derivative of Structure I and the N,N′-diurea derivative of Structure II are present in the thermally responsive layer in a weight ratio of 10:90 to 60:40 (Structure I: Structure II). In further embodiments, the N,N′-diurea derivative of Structure II is present in the thermally responsive layer in an amount by weight greater than or equal to the N,N′-diurea derivative of Structure I. In still further embodiments, the N,N′-diurea derivative of Structure I and the N,N′-diurea derivative of Structure II are present in the thermally responsive layer in a weight ratio of 20:80 to 50:50, and still further from 25:75 to 50:50.

In some embodiments, the developer further comprises diphenyl urea (DPU). In embodiments, the developer comprises from 20 wt % to 60 wt % DPU, or from 40 wt % to 55 wt % DPU.

In an embodiment, the N,N′-diurea derivative of Structure I and the N,N′-diurea derivative of Structure II account for at least 50% of the total developer by weight.

In embodiments, the thermally responsive layer has a coat weight of 1.5 g/m².

In embodiments, a print quality of the recording medium when printed with a thermal printer energy setting of 11.7 mJ/mm² at a print speed of 6 inches per second (ips) is characterized by at least one of:
(a) an initial ANSI value of at least 3.0;
(b) an ANSI value of at least 3.0 after the printed recording medium is exposed to sunflower oil for 4 hours at 40° C.;
(c) an ANSI value of at least 3.0 after the printed recording medium is exposed to sunflower oil for 4 hours at 80° C.;
(d) an ANSI value of at least 3.0 after the printed recording medium is exposed to Crisco® oil for 4 hours at 40° C.;
(e) an ANSI value of at least 3.0 after the printed recording medium is exposed to Crisco® oil for 4 hours at 80° C.;
(f) an ANSI value of at least 3.0 after the printed recording medium is exposed to olive oil for 4 hours at 40° C.; and
(g) an ANSI value of at least 3.0 after the printed recording medium is exposed to olive oil for 4 hours at 80° C.

In further embodiments, a print quality of the recording medium when printed with a thermal printer energy setting of 11.7 mJ/mm² at a print speed of 6 inches per second (ips) is characterized by at least (e) an ANSI value of at least 3.0 after the printed recording medium is exposed to Crisco® oil for 4 hours at 80° C. In still further embodiments, a print quality of the recording medium when printed with a thermal printer energy setting of 11.7 mJ/mm² at a print speed of 6 inches per second (ips) is characterized by at least (e) an ANSI value of at least 3.0 after the printed recording medium is exposed to Crisco® oil for 4 hours at 80° C. and the N,N′-diurea derivative of Structure I and the N,N′-diurea derivative of Structure II are present in the thermally responsive layer in a weight ratio of 20:80 to 50:50.

### BRIEF DESCRIPTION OF THE DRAWINGS

The inventive articles, systems, and methods are described in further detail with reference to the accompanying drawings, of which:

FIG. 1A is a schematic perspective view of a roll of direct thermal recording medium;

FIG. 1B is a magnified schematic front elevation view, which also serves as a schematic cross-sectional view, of such recording medium;

FIG. 2 is a schematic magnified view of a portion of a base coat used in the recording material of FIG. 1B.

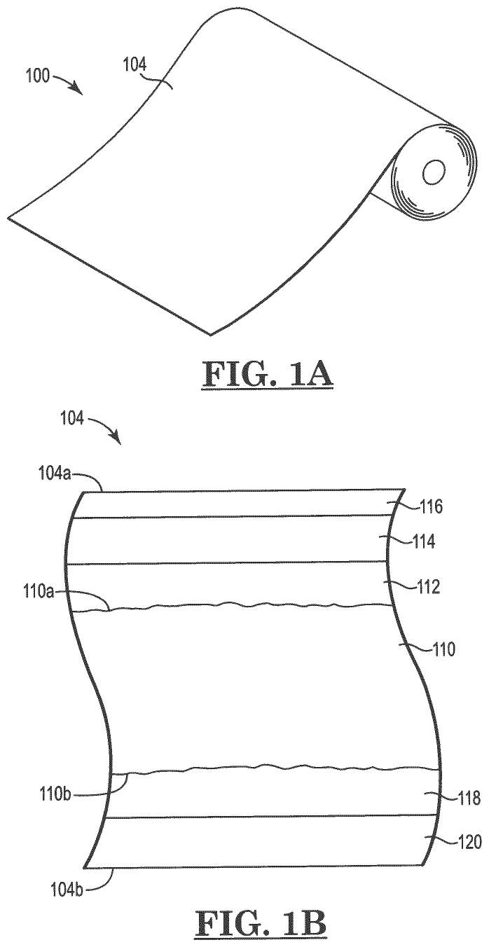

In the Figures, like reference numerals designate like elements.

### DETAILED DESCRIPTION

Unless stated to the contrary, implicit from context, or customary in the art, all parts and percents are based on volume. The terms “comprising,” “including,” “having” and their derivatives are not intended to exclude the presence of any additional component, step or procedure, whether or not the same is specifically disclosed. In order to avoid any doubt, all compositions claimed through use of the term “comprising” may include any additional additive, adjuvant, or compound unless stated to the contrary. In contrast, the term “consisting essentially of” excludes from the scope of any succeeding recitation any other component, step or procedure, excepting those that are not essential to operability. The term “consisting of” excludes any component, step or procedure not specifically delineated or listed.

As used herein, the phrase “disposed on” as used with reference to a layered structure refers to an arrangement between two planar materials in which they are in contact, either directly or indirectly, with one another.

As used herein, the phrase “water-dispersible,” when used in reference to a paper substrate, means the paper material disintegrates into its fibers upon exposure to water, either with or without agitation.

As used here, the phrase “water-soluble,” when used in reference to a paper substrate, means the paper material dissolves upon exposure to water, either with or without agitation.

The numerical ranges in this disclosure include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 5; 1 to 6; 1 to 7; 2 to 5; 2 to 6; 2 to 7; 3 to 5; 3 to 6; 3 to 7; etc.).

In embodiments of the present disclosure, a recording medium is provided. The recording medium comprises a substrate and a thermally responsive layer disposed on the substrate. The thermally responsive layer includes a leuco dye and at least one developer. The developer comprises an N,N′-diurea derivative of Structure I and an N,N′-diurea derivative of Structure II:

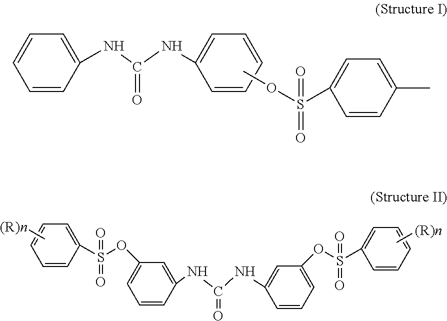

wherein each Rn group is independently an alkyl group, preferably a C₁₋₇ alkykl group, and preferably a linear or branched C₁₋₇ alkyl group. In an embodiment, each Rn group is independently selected from the group consisting of a methyl group, an ethyl group, a propyl group, an isopropyl group, an n-butyl group, a sec-butyl group, an isobutyl group, and a tert-butyl group. In a particular embodiment, the Rn groups are the same and selected from the group consisting of a methyl group, an ethyl group, a propyl group, an isopropyl group, an n-butyl group, a sec-butyl group, an isobutyl group, and a tert-butyl group. In an embodiment, the Rn groups are each a methyl group.

As shown in the Figures, a recording medium 104 may be made by applying several different coatings to at least one major surface 110a of a substrate 110. A major surface 110a may be referred to as the front surface of the substrate, and the exposed major surface 104a may be the front surface of the recording medium 104. The opposite major surface 104b may be the back surface of the recording medium.

The substrate 110 is coated to carry at least a thermally responsive layer 114. In some embodiments, the recording medium 104 includes a base coat layer 112 and a top coat layer 116. When a base coat layer 112 is included, it is preferably disposed on the substrate 110 between the substrate 110 and the thermally responsive layer 114. When a top coat layer 116 is included, it is preferably disposed on the thermally responsive layer 114 opposite the substrate 110.

The coatings may be formed by any suitable coating technique, including roll coating, knife coating, rod coating, gravure coating, curtain coating, spot coating, and so forth. Furthermore, additional layers and coatings can be added to or included with the recording material on its front and/or back side. For example, one or more coatings can be applied to the opposite side of the substrate, i.e., to the major surface 110b.

### Substrate

The substrate 110 can be any material onto which the other layers can be coated or applied, and then carried. The kind or type of substrate material is not critical. Generally, the substrate 110 is in sheet or roll form, and may be or include a support member, such as a web, ribbon, tape, belt, film, card, or the like. In this regard, a sheet denotes an article having to large (major) surface dimensions and a comparatively small thickness dimension, and in some cases, the sheet may be wound up to form a roll. In that regard, the substrate 110 is typically thin and flexible, yet strong enough to withstand forces and tensions experienced in a coating machine without undue breakage.

The substrate 110 can be opaque, transparent, or translucent, and can be colored or uncolored. The substrate material can be fibrous including, for example, paper and filamentous synthetic materials. It can be a film including, for example, cellophane and synthetic polymeric sheets cast, extruded, or otherwise formed. Suitable plastic films include films of polypropylene (including oriented polypropylene (OPP) and biaxially oriented polypropylene (BOPP)), polyethylene (PE), and polyethylene terephthalate (PET). The substrate material can thus be non-cellulosic.

An exemplary substrate 110 may be or include a neutral sized base paper. The thickness of the substrate 110 may depend on its composition, but a typical thickness (caliper) range for cellulosic materials is form 1.9 to 12 mils (e.g., 50 to 300 μm), or other suitable thicknesses. The paper may have a base weight in a range from 35 to 200 g/m², but other suitable base weights may also be used.

The substrate 110 may be simple in construction and devoid of glossy coatings, or of other substantial, functional coatings. The substrate 110 may, for example, be substantially uniform in composition throughout its thickness, rather than a multilayered construction or material to which one or more separate, functional coatings have already been applied. In some cases, however, it may be desirable to treat, prepare, or otherwise work the substrate 110 in preparation for coating onto it one or more of the other layers as shown in the Figures.

In an embodiment, the substrate 110 is water-dispersible or water-soluble. This is in contrast to ordinary paper substrates, which are neither water-soluble nor water-dispersible. Depending on its thickness and composition, the paper of the substrate 110 may be thin and flexible, similar to ordinary office paper, or it may be somewhat thicker and stiffer.

In an embodiment, a paper substrate has a thickness in a range from 2.5 mils to 20 mils. A paper substrate may have a physical strength and thickness sufficient to allow it to be manipulated and handled in a coating machine without excessive tearing or breaking. A paper substrate 110 may thus be in the form of a web with two opposed major surfaces 110a, 11b. These surfaces are shown as being uneven or rough, which is exacerbated when the surfaces are wetted.

The term “paper” is used herein to encompass all embodiments, or combination or embodiments, of paper disclosed herein.

An exemplary paper for use as the substrate 110 is Neenah Dispersa™ dispersible paper available from Neenah, Inc., Alpharettea, Ga. Neenah Dispersa™ is made from less than 15% purified pulp. Purified pulp contains at least 88 wt % of α-cellulose and/or less than 12 wt % of hemi-cellulose. The low content of purified pulp is what gives the water-dispersible properties.

There are several products under the Neenah™ Dispersa™ brand, including product code 7630P0 (3.0-3.4 mil thickness), product code 7741P0 (14 mil thickness), and product code 7742P0 (17 mil thickness). Other water-dispersible papers suitable for use as the substrate 110 are also available. Aquasol Corporation of North Tonawanda, N.Y. sells a 3 mil thick water-dispersible flexible paper under product code ASW-35/S. SmartSolve Industries (part of CMC Group, Bowling Green, Ohio) sells a number of water-dispersible paper products, such as a 3 mil thick water-dispersible flexible paper under product code IT117970.

Some commercially available water-dispersible paper of the substrate 110 may contain greater than 12% of purified pulp, as disclosed in U.S. Pat. No. 8,877,678 (Koyama et al.). The purified pulp may, for example, account for 15-95 wt % of all the pulp in the substrate.

### Thermally Responsive Layer

The thermally responsive layer 114 may also be referred to as a heat-sensitive color-forming layer. The thermally responsive layer 114 comprises a color-forming composition that is thermally sensitive, i.e., changes color upon sufficient heating. The color- forming composition has two main components: a color-forming dye (electron-donating dye precursor), also known as a leuco dye or chromogenic material, and an acidic developer. The leuco dye and acidic developer are typically ground to individual particle sizes of between 1 to 10 micrometers, dispersed in a solid matrix or binder, and distributed homogeneously and in a contiguous relationship with each other throughout the thermally responsive layer 114. Sufficient heating at any position allows the particles of acidic developer to react with the particles of leuco dye which results in a color change at the site of the heating, usually from light to dark.

Leuco dyes are generally not phenol-based, and any leuco dye may suitably be used. Exemplary leuco dyes include, but are not limited to: ODB-2 (CAS No. 89331-94-2, chemical name: spiro(isobenzofuran-1(3H),9′-(9H)xanthen)-3-one, 6′-(ethyl(4-methylphenyl)amino)-3′-methyl-2′-(phenylamino)−); BK305 (CAS No. 129473-78-5, chemical name: spiro(isobenzofuran-1(3H),9′-(9H)xanthen-3-one, 6′-(dipentylamino)-3′-methyl-2′-(phenylamino)−); and ETAC (CAS No. 59129-79-2, chemical name: spiro(isobenzofuran-1(3H),9′-(9H)xanthen)-3-one, 6′-(ethyl(4-methylphenyl)amino)-3′-methyl-2′-(phenylamino)−).

The thermally responsive layer comprises at least one developer. In an embodiment, the developer comprises an N,N′-diurea derivative of Structure I and an N,N′-diurea derivative of Structure II:

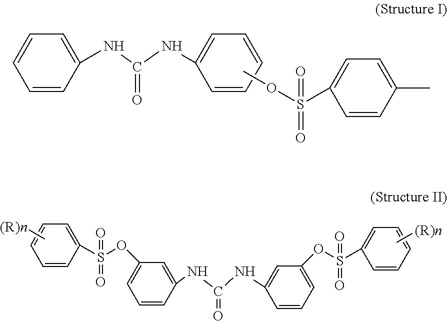

wherein each Rₙ group is independently an alkyl group, and preferably a linear or branched C1-7 alkyl group. In an embodiment, each Rₙ group is independently selected from the group consisting of a methyl group, an ethyl group, a propyl group, an isopropyl group, an n-butyl group, a sec-butyl group, an isobutyl group, and a tert-butyl group. In a particular embodiment, the Rₙ groups are the same and selected from the group consisting of a methyl group, an ethyl group, a propyl group, an isopropyl group, an n-butyl group, a sec-butyl group, an isobutyl group, and a tert-butyl group. In an embodiment, the Rₙ groups are each a methyl group.

The compounds of Structures I and II are phenol-free. On rationale for using developers that are non-phenolic in the thermally responsive layer 114 is to satisfy the market demand for phenol-free receipts, labels, and the like. As such, it is desirable in many cases, but not necessary in all cases, for not only the thermally responsive layer 114 to be phenol-free or substantially phenol-free. As used herein, the term “phenol-free” means that a composition contains no phenolic-compounds. As used herein, the term “substantially phenol-free” means that a composition has a phenol content of less than 5 wt %, or less than 1 wt %, or less than 0.5 wt %, or less than 0.1 wt %, or less than 0.075 wt %, or less than 0.05 wt %, or less than 0.04 wt %, or less than 0.03 wt %, or less than 0.02 wt %.

Some phenol-free developers can give rise to long-term image fade or image formation problems. Image fade and image formation problems are more noticeable with hot, humid storage conditions and exposure to oils, particularly high temperature oils. It was surprisingly discovered that the developer composition of an N,N′-diurea derivative of Structure I and an N,N′-diurea derivative of Structure II reduced image fade and image formation problems seen with other phenol-free developers.

In an embodiment, the N,N′-diurea derivative of Structure I and the N,N′-diurea derivative of Structure II are present in the thermally responsive layer in a weight ratio of 10:90 to 60:40 (Structure I: Structure II). In an embodiment, the N,N′-diurea derivative of Structure I and the N,N′-diurea derivative of Structure II are present in the thermally responsive layer in a weight ratio of 10:90 to 60:40, or of 15:85 to 60:40, or of 15:85 to 55:45, or of 20:80 to 55:45, or of 20:80 to 50:50, or of 25:75 to 50:50 (Structure I: Structure II). In a preferred embodiment, the the N,N′-diurea derivative of Structure I and the N,N′-diurea derivative of Structure II are present in the thermally responsive layer in a weight ratio of 10:90 to 60:40, or 20:80 to 50:50 (Structure I: Structure II).

In an embodiment, the developer further comprises diphenyl urea (DPU). The DPU is present in an amount from 20 wt %, or 25 wt %, or 30 wt %, or 35 wt %, or 40 wt % to 45 wt %, or 50 wt %, or 55 wt %, or 60 wt %. In a preferred embodiment, the DPU is present in an amount from 20 wt % to 60 wt %, or 40 wt % to 55 wt %.

In a further embodiment, the N,N′-diurea derivative of Structure I and the N,N′-diurea derivative of Structure II account for at least 50% by weight of the total developer.

The thermally responsive layer 114 may also include one or more suitable binders to hold the particles in the layer together. Exemplary binders may include, but are not limited to, poly (vinylalcohol), hydroxy ethylcellulose, methylcellulose, isopropyl cellulose, starch, modified starches, gelatin, and the like. Latex materials including polyacrylates, polyvinylacetates, polystyrene, and the like, may also be used. The binder helps maintain the mechanical integrity of the layer 114 in response to brushing or handling forces resulting from use or storage of the recording material 104. Enough of the binder should be present to provide such protection, but not so much so as to interfere with achieving reactive contact between the color-forming reactive materials. The binder may be present at 5 to 30 wt % of the dried coating.

In addition to the leuco dye, the developers, and the binder, the color-forming composition of the layer 114 may also contain one or more materials referred to as modifiers, which aid in color formation. The modifier(s) can function by one or both of (a) lowering the melting point of the dye/developer, and (b) acting as a type of solvent in which the dye and developer dissolve or melt. The modifier(s) may thus facilitate the reaction between the leuco dye and the developer to produce a more intense thermal image, faster imaging, or both. See, for example, U.S. Pat. No. 4,531,140 (Suzuki et al.), U.S. Pat. No. 4,794,102 (Petersen et al.), U.S. Pat. No. 5,098,882 (Teraji et al.), U.S. Pat. No. 6,835,691 (Mathiaparanam et al.), and U.S. Pat. No. 6,921,740 (Hizatate et al.).

The thermally responsive layer 114 has a coat weight from 0.9 g/m², or 1.0 g/m², or 1.1 g/m², or 1.2 g/m², or 1.3 g/m² to 1.4 g/m², or 1.5 g/m², or 1.6 g/m², or 1.7 g/m², or 1.8 g/m².

### Base Coat

In an embodiment, the recording medium comprises a base coat 112. A base coat 112 may be applied directly or indirectly, and preferably directly, to the substrate 110, and more specifically to a major surface 110a of the substrate 110.

In some cases the base coat 112 may be characterized or described as a thermal insulating layer, a separator layer, a heat-reflective layer, an isolation layer, or a prime coat. The base coat 112 may be tailored to have a thermal conductivity less than both the thermal conductivity of the thermally responsive layer 114 and the thermal conductivity of the substrate 110 in order to provide a degree of thermal insulation between those two layers. Such thermal insulation promotes image quality, imaging speed, or both, by ensuring that heat delivered by the thermal print head at the front surface 104a is not substantially lost by thermal conduction through the thermally responsive layer 114 to the more massive substrate 110.

Base coats may be tailored to provide a balanced combination of features, including, but not limited to, having sufficient bulk or thickness to be able to smooth over undulations or roughness of the major surface 110a of the substrate, having sufficient air content to provide good thermal insulation (low thermal conductivity), and having an internal cohesiveness that is strong enough to remain intact during normal handling of the product but weak enough to break apart (disperse) when exposed to water after the underlying substrate 110 has dissolved, or begun to dissolve, or has dispersed, or has begun to disperse.

In an embodiment, the base coat 112 preferably uses a non-water soluble binder material. A non-water soluble binder material allows the resulting recording medium to be water-dispersible (i.e., breaks apart under the influence of water with minimal agitation). The binder material of the base coat, and the base coat itself, are thus non-water-soluble, but nevertheless tailored such that the record material as a whole is water-dispersible.

Exemplary binders include non-resinous binders, particulate binders, and/or binders derived from a dispersion, such as latex.

In an embodiment, the base coat 112 has a thickness of at least 2 micrometers, and preferably from 2 to 12 micrometers, and a coat weight in a range from 1 to 5 lbs/3300 ft² (2.5 to 7.5 g/m²).

In an embodiment, base coat 112 includes hollow sphere pigments (HSP). HSP are useful in lowering thermal conductivity of the base coat 112. HSP can also improve the bulk (thickness) of a base coat 112 so as to smooth over effects of the roughening of the surface of the substrate 110. A benefit of HSP is that, if the product is calendared during the manufacturing process (after the base coat has been applied to the base stock, and dried), the HSP pigments can deform on the surface in contact with the calendar surface, under the pressure of the nip, to provide a smoother surface than can be made using conventional pigments.

Other pigments beside HSP, such as calcine clay or other clay particles, and/or other particles that have good bulk and water absorbing properties, such as precipitated calcium carbonate (PCC) or fumed silica, can also be used, but do not typically by themselves provide the bulk needed to overcome the roughness of any base stock.

In an embodiment, the base coat 112 also includes a binder. Preferred binder materials for the base coat 112 include non-water-soluble binders, non-resinous binders, particulate binders, and/or binders derived from dispersions, such as latex. Other suitable binders include, but are not limited to, cooked starch, polyvinyl alcohol (PVA) and AQ™ polymers available from the Eastman Chemical Company.

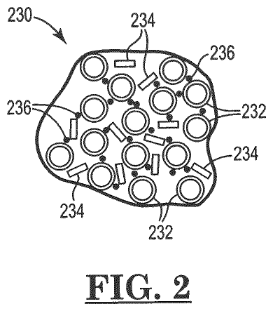

Looking to FIG. 2, a schematic depiction of a balanced binder/pigment combination is shown. A small but representative portion 230 of a base coat 112 is made up of HSP particles 232, particles 234 of a second pigment such as calcine clay, and binder particles 236 such as latex. The binder particles 236 are numerous enough to adequately hold the pigment particles together, but sparse enough to maintain an abundant number of air pockets and air gaps between the particles for adequate thermal insulation.

To provide the desired balance of characteristics, the latex or other suitable non-water-soluble binder is preferably present in the base coat 112 in a concentration from 10 wt %, or 15 wt % to 20 wt %, or 30 wt %. The HSP is preferably present in the base coat 112 in a concentration from 20 wt %, or 30 wt % to 50 wt %. The calcine clay or other suitable second pigment is preferably present in the base coat in a concentration less than 80 wt %, or in a range from 10-50 wt %.

### Top Coat

Turning to FIG. 2, a top coat layer 116 is shown atop, and in the embodiment shown in direct contact with, the thermally responsive layer 114. In the embodiment illustrated, the outer major surface of the top coat 116 is exposed to air and corresponds to the outer major surface 104a of the direct thermal recording medium 104. The top coat 116 is optional and may be omitted if desired. If a top coat is included, it can protect underlying layers from unwanted contaminants or substances. For example, top coats can be used as barrier or seals against seepage by oils or other unwanted liquids.

Various top coat designs and compositions are known and may be selected for use with this technology to meet various requirements for different uses of the recording medium. A top coat may have a thickness in a range from 0.5-2 μm.

### Additional Optional Layers

Recording medium described herein may include other optional coatings in addition to the base coat and top coat. Such layers can include coatings that can be applied to the back surface 110b of the substrate 110. One such layer is illustrated in FIG. 2, labeled 118. This layer 118 may be an adhesive layer comprising a pressure sensitive adhesive (PSA), hot melt adhesive, or other suitable adhesive. By providing on the back side of the recording medium 104, the recording medium can serve as a label and can attach to containers, films, or other bodies while having its front, thermally printed side visible to users. Such an adhesive is preferably itself water-dispersible or water-soluble so that after use, the entire label can be easily washed away and completely removed from the workpieces to which it was attached by the user, e.g., after direct thermal printing. The adhesive may be releasably carried by an optional release liner 120. A release liner can also be included to cover a PSA layer until ready for use. Release coatings may also be applied to the surface for applications that do not require a liner.

In the case of a label product, a user may remove the release liner 120 after forming a thermal image in the direct thermal layer 114, and affix the label so printed to a container or other suitable workpiece with the adhesive layer 118. After use, the label may be completely removed from the container by applying water with minimal agitation, causing the label to break apparat to restore the container to its original state.

### Exposure Conditions

Direct thermal recording media can potentially be used in a variety of settings and, as such, can be exposed to a wide variety of environmental agents, contaminants, and conditions. Images formed by direct thermal printing on such materials are known to be subject to degradation when exposed to at least one of those conditions. A given recording medium may experience degradation to more or fewer of these conditions depending on its details of construction, including the materials and composition of the thermally responsive layer.

In an embodiment, the direct thermal recording medium is designed to withstand exposure to oils, and in particular oils at high temperatures.

In some embodiments, the recording medium is used to print barcodes. The quality (readability) of a barcode is measured using standards set forth by the American National Standards Institute (ANSI). A barcode is assessed on eight different characteristics and assigned a number on a scale of 0 to 4, with 4 being the best quality.

In an embodiment, a print quality of the recording medium according to any embodiment or combination of embodiments described herein, when printed with a thermal printer energy setting of 11.7 mJ/mm² at a print speed of 6 inches per second (ips), is characterized by an initial ANSI value of at least 3.0, or at least 3.1, or at least 3.2, or at least 3.3, or at least 3.4, or at least 3.5, or at least 3.6.

In an embodiment, a print quality of the recording medium according to any embodiment or combination of embodiments described herein, when printed with a thermal printer energy setting of 11.7 mJ/mm² at a print speed of 6 ips, is characterized by an ANSI value of at least 3.0, or at least 3.1, or at least 3.2 after the printed recording medium is exposed to oil for 4 hours. In an embodiment, the oil is selected from sunflower oil, Crisco® oil, and olive oil. In an embodiment, the oil is at a temperature of 40° C. or 80° C.

In an embodiment, a print quality of the recording medium according to any embodiment or combination of embodiments described herein, when printed with a thermal printer energy setting of 11.7 mJ/mm² at a print speed of 6 ips, is characterized by an ANSI value of at least 3.0, or at least 3.1, or at least 3.2 after the printed recording medium is exposed to oil for 4 hours at a temperature of 40° C. In an embodiment, the oil is selected from sunflower oil, Crisco® oil, and olive oil.

In an embodiment, a print quality of the recording medium according to any embodiment or combination of embodiments described herein, when printed with a thermal printer energy setting of 11.7 mJ/mm² at a print speed of 6 ips, is characterized by an ANSI value of at least 3.0, or at least 3.1, or at least 3.2 after the printed recording medium is exposed to oil for 4 hours at a temperature of 80° C. In an embodiment, the oil is selected from sunflower oil, Crisco® oil, and olive oil.

In an embodiment, a print quality of the recording medium according to any embodiment or combination of embodiments described herein, when printed with a thermal printer energy setting of 11.7 mJ/mm² at a print speed of 6 ips, is characterized by an ANSI value of at least 3.0, or at least 3.1, or at least 3.2 after the printed medium is exposed to oil at both 40° C. and 80° C. for 4 hours. In an embodiment, the oil is selected from sunflower oil, Crisco® oil, and olive oil.

In an embodiment, a print quality of the recording medium according to any embodiment or combination or embodiments described herein, when printed with a thermal printer energy setting of 11.7 mJ/mm² at a print speed of 6 ips is characterized by at least one of:
(a) an initial ANSI value of at least 3.0, or at least 3.1, or at least 3.2, or at least 3.3, or at least 3.4, or at least 3.5;
(b) an ANSI value of at least 3.0, or at least 3.1, or at least 3.2, or at least 3.3, or at least 3.4, or at least 3.5 after the printed recording medium is exposed to sunflower oil for 4 hours at 40° C.;
(c) an ANSI value of at least 3.0, or 3.1, or 3.2 after the printed recording medium is exposed to sunflower oil for 4 hours at 80° C.;
(d) an ANSI value of at least 3.0, or 3.1, or 3.2, or 3.3, or 3.4, or 3.5 after the printed recording medium is exposed to Crisco® oil for 4 hours at 40° C.;
(e) an ANSI value of at least 3.0, or 3.1, or 3.2 after the printed recording medium is exposed to Crisco® oil for 4 hours at 80° C.;
(f) an ANSI value of at least 3.0, or 3.1, or 3.2 after the printed recording medium is exposed to olive oil for 4 hours at 40° C.; and
(g) an ANSI value of at least 3.0, or 3.1, or 3.2, or 3.3, or 3.4, or 3.5 after the printed medium is exposed to olive oil for 4 hours at 80° C.

In an embodiment, a print quality of the recording medium according to any embodiment or combination or embodiments described herein, when printed with a thermal printer energy setting of 11.7 mJ/mm² at a print speed of 6 ips is characterized by at least 2, or at least 3, or at least 4, or at least 5, or at least 6, or all 7 of (a)-(g). In an embodiment, a print quality of the recording medium according to any embodiment or combination of embodiments described herein, when printed with a thermal printer energy setting of 11.7 mJ/mm² at a print speed of 6 ips is characterized by at least (e), or at least (e) and one other of (a)-(d) and (f)-(g).

In an embodiment, the recording medium according to any embodiment or combination of embodiments described herein, when printed with a thermal printer energy setting of 11.7 mJ/mm² at a print speed of 6 ips is characterized by an image retention of greater than 80%, or greater than 85%, or greater than 90% when exposed to oil for 4 hours. In an embodiment, the oil is selected from sunflower oil, Crisco® oil, and olive oil. In an embodiment, the oil is at a temperature of 40° C. or 80° C.

In an embodiment, the recording medium according to any embodiment or combination of embodiments descried herein, when printed with a thermal printer energy setting of 11.7 mJ/mm² at a print speed of 6 ips is characterized by an image retention of greater than 85%, or greater than 90%, or greater than 95% when exposed to oil for 4 hours at a temperature of 40° C. In an embodiment, the oil is selected from sunflower oil, Crisco® oil, and olive oil.

In an embodiment, the recording medium according to any embodiment or combination of embodiments described herein, when printed with a thermal printer energy setting of 11.7 mJ/mm² at a print speed of 6 ips is characterized by an image retention of greater than 80%, or greater than 85%, or greater than 90% when exposed to oil for 4 hours at a temperature of 80° C. In an embodiment, the oil is selected from sunflower oil, Crisco® oil, and olive oil.

In an embodiment, the recording medium according to any embodiment or combination or embodiments described herein, when printed with a thermal printer energy setting of 11.7 mJ/mm² at a print speed of 6 ips is characterized by at least one of:
(a) an image retention of greater than 90%, or greater than 92%, or greater than 94%, or greater than 96% after the printed recording medium is exposed to sunflower oil for 4 hours at 40° C.;
(b) an image retention of greater than 85%, or greater than 90%, or greater than 92% after the printed recording medium is exposed to sunflower oil for 4 hours at 80° C.;
(c) an image retention of greater than 85%, or greater than 90%, or greater than 92%, or greater than 94% after the printed recording medium is exposed to Crisco® oil for 4 hours at 40° C.;
(d) an image retention of greater than 80%, or greater than 82%, or greater than 84%, or greater than 86%, or greater than 88% after the printed recording medium is exposed to Crisco® oil for 4 hours at 80° C.;
(e) an image retention of greater than 85%, or greater than 90%, or greater than 92%, or greater than 94% after the printed recording medium is exposed to olive oil for 4 hours at 40° C.; and
(f) an image retention of greater than 80%, or greater than 85%, or greater than 90% after the printed medium is exposed to olive oil for 4 hours at 80° C.

In an embodiment, the recording medium according to any embodiment or combination or embodiments described herein, when printed with a thermal printer energy setting of 11.7 mJ/mm² at a print speed of 6 ips is characterized by at least 2, or at least 3, or at least 4, or at least 5, or all 6 of (a)-(f). In an embodiment, the recording medium according to any embodiment or combination of embodiments described herein, when printed with a thermal printer energy setting of 11.7 mJ/mm² at a print speed of 6 ips is characterized by at least (e), or at least (e) and one other of (a)-(d) and (f).

Image retention, as used herein, refers to the change in optical density of an image on the printed recording medium from its initial density after printing (ID) to the final density (FD), that is, the optical density after exposure to oil and desired conditions. That is, image retention is illustrated hv the formula:

$$\% Image Retention = ( FD / ID ) * 100$$

In embodiments, optical density is measured using a densitometer, such as a Techkon SpectroDens Densitometer.

### Experimental Data

Examples were generated using the compositions as provided below. Examples used paper as the substrate, and a thermally responsive layer was coated on the substrate at 1.5 g/m². A top coat was applied at 1.5 g/m². The composition of the top coat was:

| | | |
|---|---|---|
| Slurry, 30% aluminum hydroxide in water* | 23.0 | parts by weight |
| Aqueous solution of polyvinyl alcohol (10%)** | 63.0 | parts by weight |
| Zinc (44% in water)*** | 1.0 | parts by weight |
| Crosslinker (12.5% in water)**** | 13.0 | parts by weight |

*available as Higilite H43M sold by SHOWA DENKOK. K.
**available as KL318 sold by KURARAY CO. LTD.
***available as H-526 sold by CYTECH PRODUCTS INC.
****available as Polyamide epochlorohydrin resin sold by SOLENIS LLC

The examples were imaged using a barcode at a print speed of 6 inches per second (ips) on the default setting on the ZEBRA 140-401 printer. Both a UPCA barcode and a solid block were imaged.

Image loss was measured using a Techkon Spectrodens Densitometer. The initial image and the image after testing were recorded. The delta of the values was divided by the initial to give a percent.

The barcode quality (ANSI value) was tested using a TruCheck TC-843 verifier at 650 nm and calibrated to ANSI Bar Code Print Quality Guideline, X3.182, published in 1990. The ANSI guideline defines eight categories of print quality that are measured.

### Materials

ODB-2: 2-anilino-3-methly-6-dibutylaminofluoran

D-8: 4-hydroxyphenyl-4-isopropoxypenylsulfone represented by the formula:

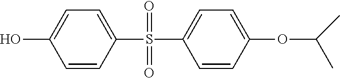 [SMILES: CC(C)Oc1ccc(S(=O)(=O)c2ccc(O)cc2)cc1]

TGSH: 2,2′-diallyl-4,4′-sulfonyldiphenol represented by the formula:

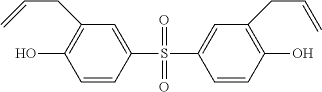 [SMILES: C=CCc1cc(S(=O)(=O)c2ccc(O)c(CC=C)c2)ccc1O]

Pergofast 201 (sold by SOLENIS LLC): N-(p-toluenesulfonyl)-N′-(3-p-toluenesulfonyloxyphenyl) urea represented by the formula:

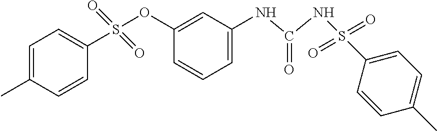

NKK-1304 (sold by Nippon Soda Co. LTD): N-[2-(3-phenylureido)phenyl]benzenesulfonamide represented by the formula:

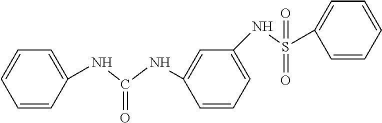 [SMILES: O=C(Nc1ccccc1)Nc1cccc(NS(=O)(=O)c2ccccc2)c1]

TGMD (sold by Nippon Kayaku Co. LTD) is a compound of Structure I: compound represented by the formula:

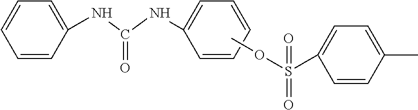

S-176 (sold by Sanko Co. LTD) is a compound of Structure II: compound represented by the formula:

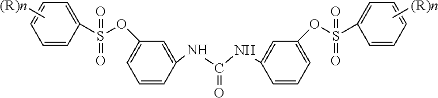

DPU: compound represented by the formula:

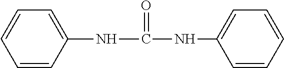 [SMILES: O=C(Nc1ccccc1)Nc1ccccc1]

DPE: 1,2-diphenoxy ethane represented by the formula:

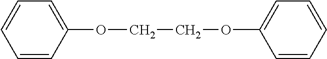 [SMILES: c1ccc(OCCOc2ccccc2)cc1]

DPS: diphenyl sulfone represented by the formula:

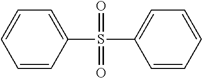 [SMILES: O=S(=O)(c1ccccc1)c1ccccc1]

The dispersions used in the experiments had the following general compositions:

### Dispersion A (Chromogenic Material)

Chromogenic Material: 30.0 parts
Binder (20% solution of polyvinyl alcohol in water): 25.0 parts
Defoaming and dispersing agents: 0.4 parts
Water: 44.6 parts

### Dispersion B (Developer Material)

Developer Material: 38.0 parts
Binder (20% solution of polyvinyl alcohol in water): 18.0 parts
Defoaming and dispersing agents: 0.4 parts
Water: 43.6 parts

### Dispersion C (Sensitizer Material)

Developer Material: 38.0 parts
Binder (20% solution of polyvinyl alcohol in water): 18.0 parts
Defoaming and dispersing agents: 0.4 parts
Water: 43.6 parts

The coating formulations in the examples had the following formulations:
Coating Formulation 1 (CF1)
Dispersion A: 22.0 parts
Dispersion B: 38.0 parts
Binder (10% solution of polyvinyl alcohol in water): 25.0 parts
Filler slurry (30% in water): 15.0 parts

### Coating Formulation 2 (CF2)

Dispersion A: 14.5 parts
Dispersion B: 25.5 parts
Dispersion C: 20.0 parts
Binder (10% solution of polyvinyl alcohol in water): 25.0 parts
Filler slurry (30% in water): 15.0 parts

The tables below provide the specific formulations for the inventive examples (IE) and comparative examples (CS).

TABLE 1

| | IE 1 | CE 1A | CE 1B | CE 1C | CE 1D | CE 1E | CE 1F | CE 1G |
|---|---|---|---|---|---|---|---|---|
| Coating | CF1 | CF1 | CF1 | CF1 | CF1 | CF1 | CF1 | CF1 |
| Formulation | | | | | | | | |
| Chromogenic | ODB-2 | ODB-2 | ODB-2 | ODB-2 | ODB-2 | ODB-2 | ODB-2 | ODB-2 |
| Material | (100%) | (100%) | (100%) | (100%) | (100%) | (100%) | (100%) | (100%) |
| Developer | TGMD (50%) | S-176 | D8 | TGSH | Pergofast | NKK-1304 | TGMD | DPU |
| Material | S-176 (50%) | (100%) | (100%) | (100%) | 201 (100%) | (100%) | (100%) | |
| Sensitizer | NA | NA | NA | NA | NA | NA | NA | NA |
| Material | | | | | | | | |

TABLE 2

| | IE 2 | CE 2A | CE 2B | CE 2C | CE 2D | CE 2E | CE 2F | CE 2G |
|---|---|---|---|---|---|---|---|---|
| Coating | CF1 | CF1 | CF1 | CF1 | CF1 | CF1 | CF1 | CF2 |
| Formulation | | | | | | | | |
| Chromogenic | ODB-2 | ODB-2 | ODB-2 | ODB-2 | ODB-2 | ODB-2 | ODB-2 | ODB-2 |
| Material | (100%) | (100%) | (100%) | (100%) | (100%) | (100%) | (100%) | (100%) |
| Developer | DPU (50%) | DPU (50%) | DPU (50%) | DPU (50%) | DPU (50%) | DPU (50%) | DPU (50%) | DPU (50%) |
| Material | TGMD (25%) | S-176 (50%) | D8 (50%) | TGSH (50%) | Pergofast | NKK 1304 | TGMD (50%) | TGMD (50%) |
| | S-176 (25%) | | | | 201 (50%) | (50%) | | |
| Sensitizer | NA | NA | NA | NA | NA | NA | NA | DPS |
| Material | | | | | | | | |

TABLE 3

| | IE 3 | CE 3A | CE 3B | CE 3C | CE 3D | CE 3E | CE 3F | CE 3G |
|---|---|---|---|---|---|---|---|---|
| Coating | CF2 | CF2 | CF2 | CF2 | CF2 | CF2 | CF2 | CF2 |
| Formulation | | | | | | | | |
| Chromogenic | ODB-2 | ODB-2 | ODB-2 | ODB-2 | ODB-2 | ODB-2 | ODB-2 | ODB-2 |
| Material | (100%) | (100%) | (100%) | (100%) | (100%) | (100%) | (100%) | (100%) |
| Developer | TGMD (50%) | S-176 | D8 | TGHS | Pergofast | NKK 1304 | TGMD | DPU |
| Material | S-176 (50%) | (100%) | (100%) | (100%) | 201 (100%) | (100%) | (100%) | (100%) |
| Sensitizer | DPE | DPE | DPE | DPE | DPE | DPE | DPE | DPE |
| Material | | | | | | | | |

The following Examples 4-14 illustrate the effect of changing the ratio of S-176 and TGMD in the developer compositions.

TABLE 4

| | Ex. 4 | Ex. 5 | Ex. 6 | Ex. 7 | Ex. 8 | Ex. 9 | Ex. 10 | Ex. 11 | Ex. 12 | Ex. 13 | Ex. 14 |
|---|---|---|---|---|---|---|---|---|---|---|---|
| Coating | CF1 | CF1 | CF1 | CF1 | CF1 | CF1 | CF1 | CF1 | CF1 | CF1 | CF1 |
| Formulation | | | | | | | | | | | |
| Chromogenic | ODB-2 | ODB-2 | ODB-2 | ODB-2 | ODB-2 | ODB-2 | ODB-2 | ODB-2 | ODB-2 | ODB-2 | ODB-2 |
| Material | | | | | | | | | | | |
| Developer | S-176 | S-176 | S-176 | S-176 | S-176 | S-176 | S-176 | S-176 | S-176 | S-176 | TGMD |
| Material | (100%) | (90%) | (80%) | (70%) | (60%) | (50%) | (40%) | (30%) | (20%) | (10%) | (100%) |
| | | TGMD | TGMD | TGMD | TGMD | TGMD | TGMD | TGMD | TGMD | TGMD | |
| | | (10%) | (20%) | (30%) | (40%) | (50%) | (60%) | (70%) | (80%) | (90%) | |
| Sensitizer | NA | NA | NA | NA | NA | NA | NA | NA | NA | NA | NA |
| Material | | | | | | | | | | | |

The results for IE1 and CE1A-1G are shown in Table 5 below. The results for IE 2 and CE 2A-2G are shown in Table 6 below. The results for IE 3 and CE 3A-3G are shown in Table 7 below. The results for Examples 4-14 are shown in Table 8 below.

TABLE 5

| | | | Sunflower Oil | | | | Crisco ® Oil | | | | Olive Oil | | | |
|---|---|---|---|---|---|---|---|---|---|---|---|---|---|---|
| | | | 40° C. | | 80° C. | | 40° C. | | 80° C. | | 40° C. | | 80° C. | |
| | Initial | | | % Image | | % Image | | % Image | | % Image | | % Image | | % Image |
| | ANSI | Image | ANSI | Retention | ANSI | Retention | ANSI | Retention | ANSI | Retention | ANSI | Retention | ANSI | Retention |
| IE 1 | 3.9 | 1.85 | 4.0 | 98% | 3.9 | 99% | 4.0 | 97% | 3.8 | 98% | 4.0 | 97% | 3.8 | 98% |
| CE 1A | 3.8 | 1.76 | 3.9 | 95% | 2.9 | 90% | 3.7 | 97% | 0.6 | 74% | 2.9 | 88% | 1.0 | 78% |
| CE 1B | 3.8 | 1.68 | 3.3 | 86% | 1.3 | 63% | 2.6 | 89% | 0.0 | 83% | 3.2 | 92% | 0.0 | 99% |
| CE 1C | 3.8 | 1.89 | 3.9 | 90% | 2.7 | 86% | 3.6 | 98% | 1.3 | 98% | 3.4 | 97% | 3.0 | 95% |
| CE 1D | 3.6 | 1.49 | 3.0 | 73% | 2.6 | 58% | 2.9 | 77% | 0.0 | 64% | 3.1 | 74% | 2.1 | 73% |
| CE 1E | 3.7 | 1.77 | 2.6 | 87% | 0.0 | 16% | 2.3 | 99% | 0.4 | 29% | 1.2 | 51% | 0.0 | 33% |
| CE 1F | 3.8 | 1.85 | 1.4 | 64% | 0.0 | 40% | 0.0 | 86% | 0.0 | 16% | 0.4 | 45% | 0.0 | 41% |
| CE 1G | 3.7 | 1.75 | 0.0 | 13% | 0.0 | 13% | 0.0 | 14% | 0.0 | 14% | 0.4 | 12% | 0.0 | 12% |

TABLE 6

| | | | Sunflower Oil | | | | Crisco ® Oil | | | | Olive Oil | | | |
|---|---|---|---|---|---|---|---|---|---|---|---|---|---|---|
| | | | 40° C. | | 80° C. | | 40° C. | | 80° C. | | 40° C. | | 80° C. | |
| | Initial | | | % Image | | % Image | | % Image | | % Image | | % Image | | % Image |
| | ANSI | Image | ANSI | Retention | ANSI | Retention | ANSI | Retention | ANSI | Retention | ANSI | Retention | ANSI | Retention |
| IE 2 | 3.9 | 1.85 | 4.0 | 97% | 3.2 | 88% | 3.9 | 91% | 3.4 | 84% | 4.0 | 93% | 3.6 | 85% |
| CE 2A | 3.8 | 1.85 | 3.8 | 89% | 2.2 | 74% | 3.8 | 88% | 0.8 | 55% | 3.3 | 89% | 1.4 | 71% |
| CE 2B | 3.8 | 1.68 | 3.8 | 86% | 0.0 | 46% | 0.0 | 69% | 0.0 | 38% | 2.8 | 101%* | 0.0 | 40% |
| CE 2C | 3.9 | 1.88 | 3.9 | 95% | 0.5 | 79% | 3.1 | 91% | 0.0 | 73% | 2.0 | 83% | 1.0 | 72% |
| CE 2D | 3.8 | 1.79 | 2.9 | 61% | 0.0 | 41% | 2.1 | 61% | 0.0 | 35% | 3.1 | 60% | 0.0 | 38% |
| CE 2E | 3.8 | 1.83 | 3.6 | 75% | 0.0 | 49% | 3.0 | 70% | 0.0 | 44% | 0.3 | 59% | 0.0 | 51% |
| CE 2F | 3.9 | 1.87 | 3.9 | 81% | 0.3 | 53% | 3.8 | 82% | 0.0 | 69% | 3.8 | 91% | 0.4 | 67% |
| CE 2G | 3.8 | 1.73 | 3.4 | 82% | 0.0 | 62% | 1.6 | 65% | 0.0 | 49% | 0.9 | 71% | 0.4 | 61% |

TABLE 7

| | | | Sunflower Oil | | | | Crisco ® Oil | | | | Olive Oil | | | |
|---|---|---|---|---|---|---|---|---|---|---|---|---|---|---|
| | | | 40° C. | | 80° C. | | 40° C. | | 80° C. | | 40° C. | | 80° C. | |
| | Initial | | | % Image | | % Image | | % Image | | % Image | | % Image | | % Image |
| | ANSI | Image | ANSI | Retention | ANSI | Retention | ANSI | Retention | ANSI | Retention | ANSI | Retention | ANSI | Retention |
| IE 3 | 3.8 | 1.75 | 3.9 | 96% | 3.9 | 97% | 3.6 | 93% | 3.3 | 91% | 3.8 | 97% | 3.9 | 94% |
| CE 3A | 3.7 | 1.70 | 3.7 | 99% | 3.0 | 92% | 3.1 | 90% | 0.9 | 75% | 3.0 | 86% | 1.1 | 74% |
| CE 3B | 3.6 | 1.58 | 3.0 | 83% | 0.0 | 75% | 0.0 | 76% | 0.0 | 35% | 0.0 | 68% | 0.0 | 63% |
| CE 3C | 3.7 | 1.8 | 3.6 | 102%* | 0.4 | 91% | 2.9 | 92% | 0.0 | 75% | 3.1 | 93% | 1.3 | 82% |
| CE 3D | 3.6 | 1.40 | 3.0 | 76% | 1.0 | 69% | 2.4 | 70% | 0.0 | 54% | 2.3 | 67% | 0.4 | 57% |
| CE 3E | 3.7 | 1.65 | 2.7 | 91% | 0.0 | 88% | 2.3 | 94% | 0.0 | 36% | 2.1 | 93% | 0.0 | 48% |
| CE 3F | 3.7 | 1.73 | 3.7 | 84% | 0.2 | 48% | 1.0 | 76% | 0.0 | 25% | 1.3 | 80% | 0.0 | 23% |
| CE 3G | 3.6 | 1.58 | 0.0 | 15% | 0.0 | 13% | 0.0 | 16% | 0.0 | 13% | 0.0 | 16% | 0.0 | 14% |

TABLE 8

| | | | | Sunflower Oil | | | | Crisco ® Oil | | | | Olive Oil | | | |
|---|---|---|---|---|---|---|---|---|---|---|---|---|---|---|---|
| | | | | 40° C. | | 80° C. | | 40° C. | | 80° C. | | 40° C. | | 80° C. | |
| | | Initial | | | % Image | | % Image | | % Image | | % Image | | % Image | | % Image |
| | Developer | ANSI | Image | ANSI | Retention | ANSI | Retention | ANSI | Retention | ANSI | Retention | ANSI | Retention | ANSI | Retention |
| Ex | 100:0 | 3.8 | 1.75 | 3.4 | 94% | 3.0 | 92% | 3.6 | 91% | 1.0 | 85% | 2.6 | 86% | 0.8 | 77% |
| 4 | S- | | | | | | | | | | | | | | |
| | 176:TGMD | | | | | | | | | | | | | | |
| Ex | 90:10 | 3.8 | 1.80 | 3.5 | 93% | 2.8 | 91% | 3.5 | 89% | 0.8 | 86% | 3.0 | 83% | 1.1 | 77% |
| 5 | S- | | | | | | | | | | | | | | |
| | 176:TGMD | | | | | | | | | | | | | | |
| Ex | 80:20 | 3.9 | 1.79 | 3.8 | 94% | 4.0 | 92% | 3.8 | 96% | 3.6 | 91% | 3.2 | 86% | 2.1 | 91% |
| 6 | S- | | | | | | | | | | | | | | |
| | 176:TGMD | | | | | | | | | | | | | | |
| Ex | 70:30 | 3.9 | 1.79 | 3.9 | 96% | 4.0 | 96% | 3.8 | 96% | 3.7 | 95% | 4.0 | 94% | 3.8 | 94% |
| 7 | S- | | | | | | | | | | | | | | |
| | 176:TGMD | | | | | | | | | | | | | | |
| Ex | 60:40 | 3.9 | 1.83 | 3.9 | 97% | 3.9 | 96% | 3.9 | 96% | 3.6 | 95% | 4.0 | 95% | 3.9 | 98% |
| 8 | S- | | | | | | | | | | | | | | |
| | 176:TGMD | | | | | | | | | | | | | | |
| Ex | 50:50 | 3.9 | 1.83 | 3.9 | 95% | 3.9 | 93% | 3.8 | 95% | 3.3 | 92% | 4.0 | 95% | 3.9 | 97% |
| 9 | S- | | | | | | | | | | | | | | |
| | 176:TGMD | | | | | | | | | | | | | | |
| Ex | 40:60 | 3.9 | 1.79 | 3.5 | 89% | 3.2 | 89% | 3.2 | 82% | 0.9 | 80% | 3.4 | 93% | 1.9 | 84% |
| 10 | S- | | | | | | | | | | | | | | |
| | 176:TGMD | | | | | | | | | | | | | | |
| Ex | 30:70 | 3.8 | 1.80 | 3.3 | 88% | 3.2 | 86% | 3.0 | 78% | 0.2 | 66% | 3.3 | 90% | 1.0 | 82% |
| 11 | S- | | | | | | | | | | | | | | |
| | 176:TGMD | | | | | | | | | | | | | | |
| Ex | 20:80 | 3.8 | 1.81 | 3.0 | 86% | 3.9 | 77% | 2.9 | 78% | 0.0 | 52% | 3.1 | 89% | 0.9 | 69% |
| 12 | S- | | | | | | | | | | | | | | |
| | 176:TGMD | | | | | | | | | | | | | | |
| Ex | 10:90 | 3.8 | 1.85 | 3.0 | 77% | 0.1 | 60% | 1.9 | 74% | 0.0 | 29% | 1.9 | 82% | 0.0 | 48% |
| 13 | S- | | | | | | | | | | | | | | |
| | 176:TGMD | | | | | | | | | | | | | | |
| Ex | 0:100 | 3.8 | 1.86 | 1.0 | 52% | 0.0 | 24% | 0.0 | 54% | 0.0 | 16% | 0.4 | 73% | 0.0 | 34% |
| 14 | S- | | | | | | | | | | | | | | |
| | 176:TGMD | | | | | | | | | | | | | | |

*Image retention values of greater than 100% in the tables above were caused by residual oil on the surface of the printed recording medium, resulting in a false reflectance value due to increased gloss.

As shown in Table 5, the developer combination of a compound of Structure I and a compound of Structure II (IE 1) performs better than developers using only one of those compounds (CE 1A and CE1F) and other developers. Specifically, IE 1 shows improved ANSI values and image retention after exposure to oil at high temperature (i.e.,) 80°.

The addition of DPU to a developer composition is known to decrease or lower image quality, and specifically the ANSI value and image retention. Surprisingly, as shown in Table 6, the addition of DPU to the developer combination of a compound of Structure I and a compound of Structure II does not impact the image quality as much as it does with the other developers. IE 2 shows consistent ANSI values over 3.0, even after exposure to oil at high temperatures (i.e., 80° C.), whereas each of the comparative examples shows an ANSI value of below 3.0, and in most cases below 1.0, after exposure to oil at 80° C.

The results in Table 7 show the effects of the addition of a sensitizer. While the addition of the sensitizer had a generally negative affect on most formulations (inventive and comparative) as compared to the results in Table 5, the negative effect was not significant enough on IE 3 to significantly decrease the ANSI values and image retention, particularly after oil exposure at high temperatures (i.e., 80° C.).

Table 8 shows the effect of varying the proportion of the compound of Structure I and the compound of Structure II in the developer composition. The ANSI values an image retention for the compositions containing from 20:80 to 50:50 TGMD: S-176 show significant stability across all conditions. In particular, examples 6-9 show ANSI values over 3.0 after exposure to Crisco® oil for 4 hours at 80° C., while the remaining examples show a significant decrease in ANSI values to less than or equal to 1.0.

From the foregoing, it will be appreciated that although specific embodiments or examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

It is specifically intended that the present invention not be limited to the embodiments, examples and illustrations contained herein, but include modified forms of those embodiments or examples including portions of the embodiments or examples and combinations of elements of different embodiments or examples as come within the scope of the following claims.

What is claimed is:

1. A recording medium, comprising:
a substrate; and
a thermally responsive layer disposed on the substrate, the thermally responsive layer including a leuco dye and at least one developer;
wherein the developer comprises an N,N′-diurea derivative of Structure I and an N,N′-diurea derivative of Structure II: 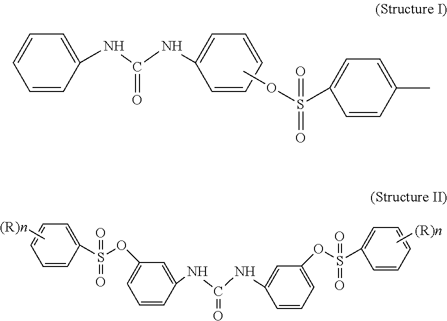
wherein each Rₙ is, independently, a C₁₋₇ alkyl group.

2. The recording medium of claim 1, wherein each Rₙ is independently selected from the group consisting of a methyl group, an ethyl group, a propyl group, an isopropyl group, an n-butyl group, a sec-butyl group, an isobutyl group, and a tert-butyl group.

3. The recording medium of claim 2, wherein each Rₙ is the same and is a methyl group.

4. The recording medium of claim 1, wherein the N,N′-diurea derivative of Structure I and the N,N′-diurea derivative of Structure II are present in the thermally responsive layer in a weight ratio of 10:90 to 60:40 (Structure I:Structure II).

5. The recording medium of claim 4, wherein the N,N′-diurea derivative of Structure II is present in the thermally responsive layer in an amount by weight greater than or equal to the N,N′-diurea derivative of Structure I.

6. The recording medium of claim 5, wherein the N,N′-diurea derivative of Structure I and the N,N′-diurea derivative of Structure II are present in the thermally responsive layer in a weight ratio of 20:80 to 50:50.

7. The recording medium of claim 6, wherein the N,N′-diurea derivative of Structure I and the N,N′-diurea derivative of Structure II are present in the thermally responsive layer in a weight ratio of 25:75 to 50:50.

8. The recording medium of claim 1, wherein the developer further comprises diphenyl urea (DPU).

9. The recording medium of claim 8, wherein the developer comprises from 20 wt % to 60 wt % DPU.

10. The recording medium of claim 9, wherein the developer comprises from 40 wt % to 55 wt % DPU.

11. The recording medium of claim 8, wherein the N,N′-diurea derivative of Structure I and the N,N′-diurea derivative II account for at least 50% of the total developer by weight.

12. The recording medium of claim 1, wherein the thermally responsive layer has a coat weight of 1.5 g/m².

13. The recording medium of claim 1, wherein a print quality of the recording medium when printed with a thermal printer energy setting of 11.7 mJ/mm² at a print speed of 6 inches per second (ips) is characterized by at least one of:
(a) an initial ANSI value of at least 3.0;
(b) an ANSI value of at least 3.0 after the printed recording medium is exposed to sunflower oil for 4 hours at 40° C.;
(c) an ANSI value of at least 3.0 after the printed recording medium is exposed to sunflower oil for 4 hours at 80° C.;
(d) an ANSI value of at least 3.0 after the printed recording medium is exposed to Crisco® oil for 4 hours at 40° C.;
(e) an ANSI value of at least 3.0 after the printed recording medium is exposed to Crisco® oil for 4 hours at 80° C.;
(f) an ANSI value of at least 3.0 after the printed recording medium is exposed to olive oil for 4 hours at 40° C.; and
(g) an ANSI value of at least 3.0 after the printed recording medium is exposed to olive oil for 4 hours at 80° C.

14. The recording medium of claim 13, wherein a print quality of the recording medium when printed with a thermal printer energy setting of 11.7 mJ/mm² at a print speed of 6 inches per second (ips) is characterized by at least (e) an ANSI value of at least 3.0 after the printed recording medium is exposed to Crisco® oil for 4 hours at 80° C.

15. The recording medium of claim 14, wherein the N,N′-diurea derivative of Structure I and the N,N′-diurea derivative of Structure II are present in the thermally responsive layer in a weight ratio of 20:80 to 50:50.

16. The recording medium of claim 3, wherein the N,N′-diurea derivative of Structure I and the N,N′-diurea derivative of Structure II are present in the thermally responsive layer in a weight ratio of 10:90 to 60:40 (Structure I:Structure II).

17. The recording medium of claim 16, wherein a print quality of the recording medium when printed with a thermal printer energy setting of 11.7 mJ/mm² at a print speed of 6 inches per second (ips) is characterized by at least one of:
(a) an initial ANSI value of at least 3.0;
(b) an ANSI value of at least 3.0 after the printed recording medium is exposed to sunflower oil for 4 hours at 40° C.;
(c) an ANSI value of at least 3.0 after the printed recording medium is exposed to sunflower oil for 4 hours at 80° C.;
(d) an ANSI value of at least 3.0 after the printed recording medium is exposed to Crisco® oil for 4 hours at 40° C.;
(e) an ANSI value of at least 3.0 after the printed recording medium is exposed to Crisco® oil for 4 hours at 80° C.;
(f) an ANSI value of at least 3.0 after the printed recording medium is exposed to olive oil for 4 hours at 40° C.; and
(g) an ANSI value of at least 3.0 after the printed recording medium is exposed to olive oil for 4 hours at 80° C.

18. The recording medium of claim 17, wherein the developer further comprises diphenyl urea (DPU).

19. The recording medium of claim 18, wherein a print quality of the recording medium when printed with a thermal printer energy setting of 11.7 mJ/mm² at a print speed of 6 inches per second (ips) is characterized by at least (e) an ANSI value of at least 3.0 after the printed recording medium is exposed to Crisco® oil for 4 hours at 80° C.

20. The recording medium of claim 19, wherein the thermally responsive layer has a coat weight of 1.5 g/m².
